(19) United States
(12) Patent Application Publication
(10) Pub. No.: US 2006/0277904 A1
(43) Pub. Date: Dec. 14, 2006

(54) Hydraulic accumulator especially piston-type accumulator

(76) Inventor: Norbert Weber, Sulzbach/Saar (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/563,364

(22) PCT Filed: Mar. 20, 2004
(86) PCT No.: PCT/EP04/02964

§ 371 Date: Jul. 18, 2006

(30) Foreign Application Priority Data
Jul. 5, 2003 (DE) 103 30 516.5

(51) Int. Cl. F16D 31/02

(52) U.S. Cl. 60/413

(57) ABSTRACT

The invention relates to a hydraulic accumulator, especially a piston-type accumulator, comprising an accumulator housing (10) as well as at least one gas chamber (12) that is arranged therein and a fluid chamber (14) which are separated from each other via a separating element (16), particularly in the form of a piston. One free end of the accumulator housing (10) is sealed via a valve block (24) that is provided with a ball valve (28) which opens or blocks a fluid-guiding path (30) from the interior of the accumulator housing (10) towards the outside in the open position or closed position thereof such that the ball valve forms an integral part of the accumulator housing via the valve block and is thus accommodated in a compact manner within the hydraulic accumulator solution, also resulting in a reduction of the free fluid paths and therefore a reduction of tubing.

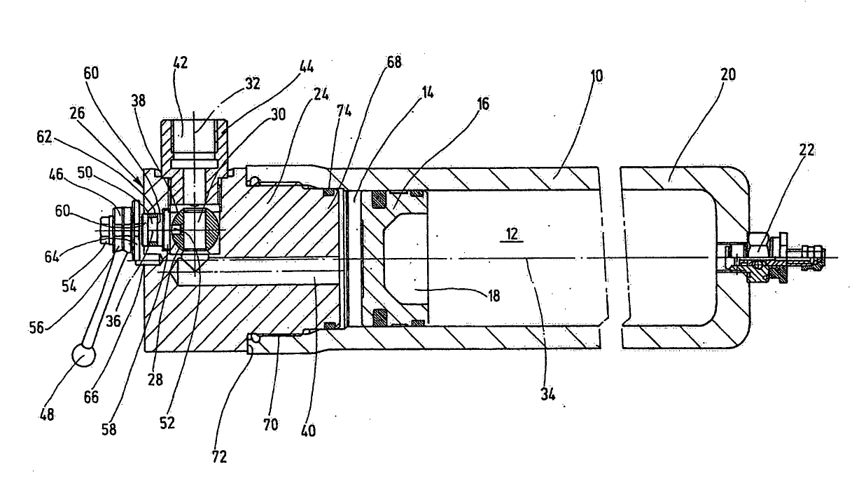

The invention relates to a hydraulic accumulator, especially a piston-type accumulator, having an accumulator housing and at least one gas chamber located therein and a fluid chamber which are separated from each other by a separating element, especially in the form of a piston.

One of the primary tasks of hydraulic accumulators is to hold specific volumes of pressurized fluids of a hydraulic system and to return them to the system again on demand. Hydraulic accumulators are generally piston accumulators, bladder accumulators, diaphragm accumulators, but also weighted and spring-loaded accumulators. With these hydraulic accumulators a plurality of tasks can be performed, such as energy storage, impact, vibration and pulsation damping, energy recovery, volumetric flow compensation, etc.

Valve control units which are generally provided with switching or directional control valves for managing the fluid flow to and from the hydraulic accumulator are used for operation and triggering of hydraulic accumulators. The hydraulic accumulator is generally connected to tubing with fluid lines which establish the fluid-carrying connection between the accumulator and the valve control unit. The disadvantages of the known solution, as can be readily obtained on the market in a plurality of embodiments, consist of tightness problems due to the increased number of connections between the hydraulic accumulator tubing and valve control unit and also the added costs for the network of fluid lines. Especially under tight installation conditions problems arise moreover in intelligently accommodating the plurality of components indicated and connecting them to each other so as to carry fluid. Since moreover different manufacturers are responsible for hydraulic accumulators, the tubing, and/or the valves of the valve control unit, on-site matching problems arise especially at the installation sites.

In DE-A-39 41 241, it has already been proposed for a piston accumulator, especially for drive slip-controlled brake systems, that a switching valve in the form of a charging valve be provided in a space-saving design with its direction of motion transversely to the direction of motion of the accumulator piston, and of a structural part which encloses it as the separating element of the accumulator, and that it be configured in the valve block of the valve control unit of the piston accumulator by way of a control switch as the motion sensor for the structural part. As a result of the electrical control components of this known piston accumulator it is complex to manufacture and thus expensive, and when the electrical components fail, operating shutdowns occur.

WO 02/40871 A2 discloses a generic hydraulic accumulator, especially a piston accumulator, having an accumulator housing with a gas chamber located therein and a fluid chamber which are separated from each other by a separating element, and the fluid chamber can be charged with a pressure medium or at least partially emptied of the latter by way of a valve control unit having a switching valve, and the switching valve being housed in the respective valve receptacle which can be moved from an open position into a closed position and vice versa in the direction of motion of the separating element in the form of a piston. The valve control unit in the known design is accommodated in a valve block which is independent of the housing, the valve block having another valve receptacle for another switching valve which performs another switching task. In that for modular use the two indicated switching valves are made as identical parts, a complex line network between the hydraulic accumulator and valve control unit is avoided and tightness or leakage problems as are common in the line network cannot occur at all. This hydraulic accumulator design is complex and thus expensive to produce, and if electrically triggered valve systems are used, a complex control configuration is necessary; this leads to the above described disadvantages relative to operating reliability.

DE 101 61 475 A1 discloses another generic hydraulic accumulator solution with an accumulator-connecting block with ports for connecting the accumulator vessel of a hydraulic pump and a tank and with a 3-way valve for blocking and relieving the accumulator vessel. The blocking element of the 3-way valve is designed as a ball, with an operating shaft for stationary configuration of the centrically mounted blocking element, and with a circumferential surface which has apertures adjoining each respective sealing configuration which is assigned to each exit. In this known solution of an accumulator-connecting block a sealed seat of the blocking element which is designed as a ball is ensured in each position of the valve. In the known solution the accumulator-connecting block is spatially separated from the actual hydraulic accumulator.

On the basis of this prior art, the object of the invention is to devise a hydraulic accumulator, which, while preserving the advantages in the prior art, requires altogether less installation space and which permits favorable fluid guidance of the fluid flows to be managed, further improves said accumulator such that it is economical to produce and maintain and permits reliable operation, especially when used in suspension systems in vehicles, such as excavators, farm tractors, etc. This object is achieved by a hydraulic accumulator with the features specified in claim 1 in its entirety.

In that, as specified in the characterizing part of claim 1, one free end of the accumulator housing is closed off by the valve block having a ball valve which in its open position or closed position clears or blocks a fluid-carrying path from the interior of the accumulator housing to the exterior, the ball valve by way of the valve block is an integral component of the accumulator housing and in this way is accommodated in a space-saving design within the hydraulic accumulator solution; this also leads to a reduction of the free fluid paths and therefore to savings as regards tubing. With the solution as claimed in the invention the accumulator housing is closed off by a valve block having a ball valve, which thus forms a part of the pressure-bearing wall of the hydraulic accumulator; this leads to a high-strength connection between the indicated components, the accumulator, and accumulator block.

Since this configuration can be built as a modular system, a wide range of applications can be covered by the components comprising the accumulator housing, valve block, and ball valve by the respective components being matched as identical modules to the fluid flows to be managed and their pressures.

If for actuation of the ball valve electrical actuating means are omitted, a purely mechanical solution is thus achieved for the hydraulic accumulator, which is extremely reliable and which permits operation of the hydraulic accumulator in a very cost-effective way. If such a hydraulic accumulator is used in a suspension system with a suspension accumulator which is turned on by way of the fluid-carrying path to the hydraulic accumulator, in the open position the ball valve being opened for springing of the suspension accumulator, and being diverted in its blocked position such that the suspension is blocked, a very simple, economical solution is attained for triggering and controlling a suspension system as is used in particular in excavators, agricultural machinery, and the like. Thus, for example, the damping of the suspension system in a machine such as a wheel loader can be turned off by way of the integrated ball valve of the hydraulic accumulator as soon as tasks such as picking up a load are carried out with the bucket of the wheel loader, so that in this way harmful oscillation processes for the wheel loader itself are avoided, and as soon as transport tasks with or without a load, for example in roadway operation, arise, the suspension accumulator is turned on by way of the ball valve of the hydraulic accumulator. If the ball valve is actuated manually by an operator, in this area any electrical control components are eliminated so that the solution as claimed in the invention can be very economically implemented and is reliable over the long term in operation.

Other advantageous embodiments of the hydraulic accumulator as claimed in the invention are the subject matter of the dependent claims.

The hydraulic accumulator as claimed in the invention is detailed below using the drawing. The single FIGURE shows schematically and not to scale a longitudinal representation of the hydraulic accumulator partially in a section, partially in a front view.

The hydraulic accumulator as shown in the figure is configured as a piston accumulator. It has an accumulator housing 10 with a gas chamber 12 located therein and a fluid chamber 14. The gas chamber 12 is separated from the fluid chamber 14 by a separating element 16 in the form of a piston which with its sealing system is guided so as to be longitudinally displaceable along the inner circumference of the accumulator housing 10 so that the ratio of gas chamber 12 to fluid chamber 14 is kept variable. In order to be able to store a larger amount of working gas (nitrogen gas) in the gas chamber 12, the piston element or separating element 16 is designed as a hollow part and inside has a corresponding recess 18. Viewed in the direction of looking at the figure, the gas chamber 12 is sealed to the exterior on its right side by a flanged cover part 20 which has a center hole with a gas valve body 22 by way of which the working gas, for example in the form of nitrogen gas, can be delivered into the gas chamber 12. The accumulator housing 10 is sealed gastight by the gas valve body 22, and by the valve 22 the amount of gas in the gas chamber 12 can be rechecked from time to time and can be added by way of a refill means (not shown).

The valve control unit which is designated as a whole as 26 is connected to the opposing ends of the accumulator housing 10 in the form of a control unit or valve block 24. The valve control unit 26 has a ball valve 28 which is shown in its open position in the figure, in which it clears a fluid-carrying path 30 to the exterior from the inside of the accumulator housing 10, here in the form of a fluid chamber 14. In its position, which on the other hand has been pivoted by 90°, it blocks the respective fluid-carrying path 30 fluid-tight. The passage direction of the ball valve 28 shown in the figure in its open position therefore runs over the transverse axis crosswise to the longitudinal axis 34 of the accumulator housing 10.

Furthermore, the pivot axis 36 of the blocking part 38 (plug) of the ball valve 28 is mounted off-center and parallel to the longitudinal axis 34 of the accumulator housing 10. The part 40 of the fluid-carring path 30 within the valve block 24 runs parallel and off-center and viewed in the direction of looking at the figure essentially underneath the longitudinal axis 34 of the accumulator housing 10. Then the blocking part (plug) 38 of the ball valve 28 is configured diametrically opposite to this part 40 and relative to the longitudinal axis 34 of the accumulator housing. Another part 42 of the fluid-carrying path 30 is formed by a screwed part 44 which, running transversely to the longitudinal axis 34 of the accumulator housing 10, is screwed into the valve block 24 on the outer circumferential side in the direction of the transverse axis 32.

To actuate the blocking part 38 of the ball valve 28, a handle 46 is used which has an actuating knob 48. The handle 46 moreover has a pivot pin 50 which with its one free end engages a groove-shaped recess 52 of the spherical blocking part 38. On its other free end the pivot pin 50 is provided with an engagement screw 54 which holds the actuating knob 48 on the pivot pin 50 torsionally strong this way, for which purpose the actuating knob 48 is provided with a collar 56 which positively encloses the pivot pin 50 in this area. Otherwise the pivot pin 50 is pivot-mounted by way of a flange-like widening 58 in the valve block 24 and the pivot pin 50 between two edge-like segments 60 has a ring seal 62 which in this way seals the interior of the valve block 24, especially with respect to the fluid-carrying path 30, relative to the surroundings.

Furthermore, on the front end of the valve block 24 the pivot pin 50 is provided with a stop ring 64 which interacts with a stop pin 66 which fixed in the valve block 24 runs essentially along the longitudinal axis 34 of the accumulator housing 10. In this way the blocking part 38 (plug) can be pivoted out of its open position shown in the figure by 90° into a blocking position (not detailed) by the actuating knob 48 and the pivot pin 50, this pivoting being limited by the stop ring 64 with the stop pin 66, in the same way as the possible pivot path when the blocking part 38 is being reset from its blocking position into the open position shown in the figure. These stop means are customary for ball valves so that they are not detailed here.

The accumulator housing 10 is designed preferably as a hollow cylindrical body and the valve block 24 meshes by way of a cylindrical extension 68 and by way of a screwed section 70 with one free end of the accumulator housing 10. This extension 68 widens flange-like and radially outside the accumulator housing 10, the flange-like edge 72 of the valve block 24 obtained in this way forming a stop surface for the front end of the accumulator housing 10 which is supported in this way on the edge 72 in the screwed-on state on the valve block 24. Furthermore, the cylindrical extension 68 tapers in the direction of the fluid chamber 14 and in the area of the respective taper has a sealing part 74 which seals the fluid chamber 14 against the exterior in this area.

The described hydraulic accumulator is made as a piston accumulator and can preferably be a component of a suspension system which is not detailed, with at least one suspension accumulator which is not detailed, for example in the form of a conventional bladder or diaphragm accumulator. This suspension accumulator which is not detailed is connected by way of the fluid-carrying path 30 to the screwed part 44 of the hydraulic accumulator either directly or by additional tubing from its fluid side. In the open position of the ball valve 28 shown in the figure, damping of the suspension can be connected, in which the fluid chamber 14 of the accumulator housing 10 is connected to the fluid side of the suspension accumulator and in this way pressure surges by the damping action of the gas part of the suspension accumulator are effected. If the intention at this point is to eliminate this damping action of the suspension accumulator, the handle 46 is actuated by the actuating knob 48 and blocking part 38 (plug) of the ball valve 28 is moved into its position which blocks the fluid-carrying path 30. In this way the suspension part of the suspension accumulator is diverted and accordingly the damping means is blocked. With the damping blocked, then for example with the shovel of a wheel loader for which the described hydraulic accumulator is used, it is possible to drive into the earth, bulk material, or the like, without pitching movements unintentionally occurring on the vehicle in the form of a wheel loader itself. The latter clearly improves working with the shovel unit of a wheel loader. When the load is then picked up by the shovel, the suspension can be turned on again for transport away on a road or the like, by the ball valve 28 being moved in the reverse sequence, as described, by the actuating knob 48 into its open position shown in the figure, in which the damping part of the suspension accumulator is then turned on again by way of the fluid-carrying path 30.

The hydraulic accumulator as claimed in the invention need not be limited to applications in wheel loaders, but can be used anywhere in suspension systems where damping devices such as suspension accumulators or the like are to be easily and reliably turned on and off, for example in the area of cultivating devices in agricultural machinery, if possible without complex control electronics. But it is also within the scope of the invention to replace the manually actuated handle 46 with an electrical actuating drive in the form of a servomotor in order to thus enable automatic triggering of the hydraulic accumulator, for example from a driver's compartment or the like. If in addition to the electrical actuating means the handle 46 with the actuating knob 48 remains, emergency actuation would in this way be possible if the electrical actuating components should fail.

In another embodiment of the hydraulic accumulator as claimed in the invention which is not detailed, it can also be provided that the ball valve be mounted obliquely in the middle, and the ball valve could also be mounted with its pivot axis offset by 90° relative to the illustrated installation position.

1. Hydraulic accumulator, especially piston-type accumulator, having an accumulator housing (10) and at least one gas chamber (12) located therein and a fluid chamber (14) which are separated from each other by a separating element (16), especially in the form of a piston, characterized in that one free end of the accumulator housing (10) is closed off by the valve block (24) having a ball valve (28) which in its open position or closed position clears or blocks a fluid-carrying path (30) from the interior of the accumulator housing (10) to the exterior.

2. The hydraulic accumulator as claimed in claim 1, wherein the passage direction (32) of the ball valve (28) in its open position runs crosswise to the longitudinal axis (34) of the accumulator housing (10) and wherein the pivot axis (36) of the blocking part (38) of the ball valve (28) is mounted off-center and parallel to the longitudinal axis (34) of the accumulator housing (10).

3. The hydraulic accumulator as claimed in claim 2, wherein one part (40) of the fluid-carrying path (30) is mounted parallel and essentially off-center to the longitudinal axis (34) of the accumulator housing (10) and wherein the blocking part (38) of the ball valve (28) is mounted diametrically opposite to this longitudinal axis (34).

4. The hydraulic accumulator as claimed in claim 1, wherein another part (42) of the fluid-carrying path (30) is formed by a screwed part (44) which, running transversely to the longitudinal axis (34) of the accumulator housing (10), is screwed into the valve block (24) on the outer circumferential side.

5. The hydraulic accumulator as claimed in claim 2, wherein the blocking part (38) of the ball valve (28) can be actuated by hand by a handle (46) and wherein there is a valve block (24) between the handle (46) and the accumulator housing (10).

6. The hydraulic accumulator as claimed in claim 5, wherein the actuating knob (48) of the handle (46) in the open position of the ball valve (28) is oriented in the opposite direction like the other part (42) of the fluid-carrying path (30) formed by the screwed part (44).

7. The hydraulic accumulator as claimed in claim 1, wherein the valve block (24) by way of cylindrical extension (68) and by way of a screwed section (70) can be screwed into one free end of the accumulator housing (10), wherein this extension (68) widens radially in the form of a flange outside the accumulator housing (10), and wherein this flange-like edge (72) of the valve block (24) forms a stop surface for the front end of the accumulator housing (10).

8. The hydraulic accumulator as claimed in claim 7, wherein in the direction of the free end of the extension (68) the valve block (24) on the outer circumferential side has at least one sealing part (74).

9. Suspension system, consisting of a hydraulic accumulator as claimed in claim 1, and at least one suspension accumulator which is connected to the hydraulic accumulator by way of the fluid-carrying path (30), wherein in the open position of the ball valve (28) for the purpose of suspension the suspension accumulator is turned on and in its blocked position is diverted such that the suspension is blocked to the greatest extent possible.
